(19) United States
(12) Patent Application Publication
(10) Pub. No.: US 2013/0277336 A1
(43) Pub. Date: Oct. 24, 2013

(54) DEVICES AND METHODS FOR DISSECTING FASTENER HEAD AND SLEEVE BUFFER

(71) Applicant: Mervyn Rudgley, Mission Viejo, CA (US)

(72) Inventor: Mervyn Rudgley, Mission Viejo, CA (US)

(73) Assignee: Perfect Point EDM Corporation, Huntington Beach, CA (US)

(21) Appl. No.: 13/882,820

(22) PCT Filed: Nov. 3, 2010
(86) PCT No.: PCT/US10/55316

§ 371 Date: Jul. 11, 2013

(51) Int. Cl. B23H 1/04

(52) U.S. Cl. CPC B23H 1/04
USPC 219/69.15; 219/69.17

(57) ABSTRACT

A device and method for removal of fasteners by force-less electrical erosion and disintegration (“FEED”) such that portions of the fastener, such as a flange, may be separated from other portions of the fastener, such as a shank and sleeve, further facilitate removal of the same. The device and method may be applied to fasteners having a rotationally loose fit within the sleeve.

### BACKGROUND

### Field

This disclosure relates to electrical discharge machining and forceless electrical erosion and disintegration (“FEED”).

### SUMMARY

According to some exemplary implementations, disclosed is a forceless electrical erosion and disintegration (“FEED”) device, comprising: an erosion electrode having an outer diameter exceeding the outer diameter of a shank of a fastener and less than the outer diameter of a sleeve surrounding at least a portion of the fastener, the erosion electrode further having an inner diameter less than the outer diameter of the shank; wherein the erosion electrode is configured to be advanced longitudinally through a head of the fastener, at least a portion of the shank, and at least a portion of the sleeve.

The erosion electrode may be a hollow cylinder. The erosion electrode may be a solid cylinder and the inner diameter of the erosion electrode may be zero. The erosion electrode may be a plurality of pins. The erosion electrode may be configured to be rotated as it is advanced longitudinally.

The erosion electrode may be configured to be rotated about an axis of rotation corresponding to a central axis of the fastener. The FEED device may further comprise: a power supply configured to provide a voltage difference between the erosion electrode and at least one of the fastener and the sleeve. The FEED device may further comprise: a ground electrode configured to contact at least one of the fastener and the sleeve. The FEED device may provide no significant torque to a fastener.

According to some exemplary implementations, disclosed is a method, comprising: providing an erosion electrode to a fastener in at least one frame, the fastener having a sleeve surrounding at least a portion thereof, and the fastener having a head and a shank; creating an eroded space without contacting the electrode to the fastener or the sleeve, the eroded space having an outer diameter exceeding the outer diameter of the shank and less than the outer diameter of the sleeve, the eroded space having an inner diameter less than the outer diameter of the shank, and the eroded space extending through the head of the fastener, at least a portion of the shank, and at least a portion of the sleeve.

Creating an eroded space comprises: providing a voltage difference between the erosion electrode and at least one of the fastener and the frame coating. Creating an eroded space comprises: advancing the erosion electrode longitudinally along an axis of the fastener. Creating an eroded space further comprises: rotating the erosion electrode as it is advanced longitudinally.

The erosion electrode may be a hollow cylinder. The erosion electrode may be a solid cylinder and the inner diameter of the eroded space may be zero. The erosion electrode may be a plurality of pins. A flange of the head may be separated from a remainder of the fastener. The method may leave the frame intact.

Advancing the erosion electrode longitudinally along the axis of the fastener may further comprise: sensing and recording a contact location when the erosion electrode is in contact with an outer surface of the fastener; tracking a longitudinal distance traveled relative to the contact position; stopping advancement of the erosion electrode when the longitudinal distance traveled is equal to the distance between the contact position and at least one location beyond the head of the fastener.

The method may further comprise: separating the head and the shank in opposite directions. The method may further comprise: removing the sleeve from the at least one frame. The at least one frame may further comprise a first frame and a second frame with opposing surfaces, whereby the method enable separation of the first frame from the second frame.

The fastener may have a rotationally loose fit within the sleeve. The fastener may have an interference fit within the sleeve.

### DRAWINGS

The above-mentioned features of the present disclosure will become more apparent with reference to the following description taken in conjunction with the accompanying drawings wherein like reference numerals denote like elements and in which:

FIG. 1 shows a sectional view of a fastener assembly in a pre-assembled state and a first and second frame;

FIG. 2 shows a sectional view of a fastener assembly in an assembled state with a first and second frame;

FIG. 3 shows a sectional view of an erosion electrode approaching a fastener assembly;

FIG. 4 shows a sectional view of an erosion electrode penetrating a fastener assembly;

FIG. 5 shows a sectional view of an eroded space in a fastener assembly;

FIG. 6 shows a sectional view of a head of a fastener removed from a shank of the fastener;

FIG. 7 shows a sectional view of a sleeve removed from a first frame and a second frame;

FIG. 8 shows a sectional view of an erosion electrode approaching a fastener assembly;

FIG. 9 shows a sectional view of an erosion electrode penetrating a fastener assembly;

FIG. 10 shows a sectional view of an eroded space in a fastener assembly; and

FIG. 11 shows a sectional view of a head of a fastener removed from a shank of the fastener.

### FURTHER DESCRIPTION

As used herein, “interference fit” is a fastening between at least two parts which is achieved by friction after the parts are pushed together (i.e., press fit, friction fit, etc.). Examples of interference fit include tensile and compression forces restricting relative motion of parts of an assembly.

As used herein, “rotationally loose fit” is a fastening between at least two parts which permits a degree of relative rotation.

As used herein, “axially tight fit” is a fastening between at least two parts which refuses any significant degree of relative motion along an axis.

As used herein, “outer diameter” of an erosion electrode corresponds to the radially outermost limit or distance from a central axis of the erosion electrode, as determined at one or more points in time during a process. The outer diameter may be selected to be homogeneous or non-homogeneous.

As used herein, “inner diameter” of an erosion electrode corresponds to the radially innermost limit or distance from a central axis of the erosion electrode, as determined at one or more points in time during a process. The inner diameter may be selected to be homogeneous or non-homogeneous.

As used herein, “eroded space” is a space that was previously occupied by a workpiece and is created by an erosion process.

According to one or more exemplary implementations, a forceless electrical erosion and disintegration (“FEED”) process includes the advancement of an electrode into a workpiece to erode, shape, define, or otherwise modify the workpiece as a product of one or more dielectric breakdown events between the electrode and the workpiece. Further disclosure of configurations and uses of EDM devices are provided in U.S. Patent Publication No. 2010/0096365, published Apr. 22, 2010; WIPO Publication No. WO 2010/048339, published Apr. 29, 2010; and U.S. Pat. No. 6,225,589, issued on May 1, 2001, the entirety of which are incorporated by reference, as if fully set forth herein.

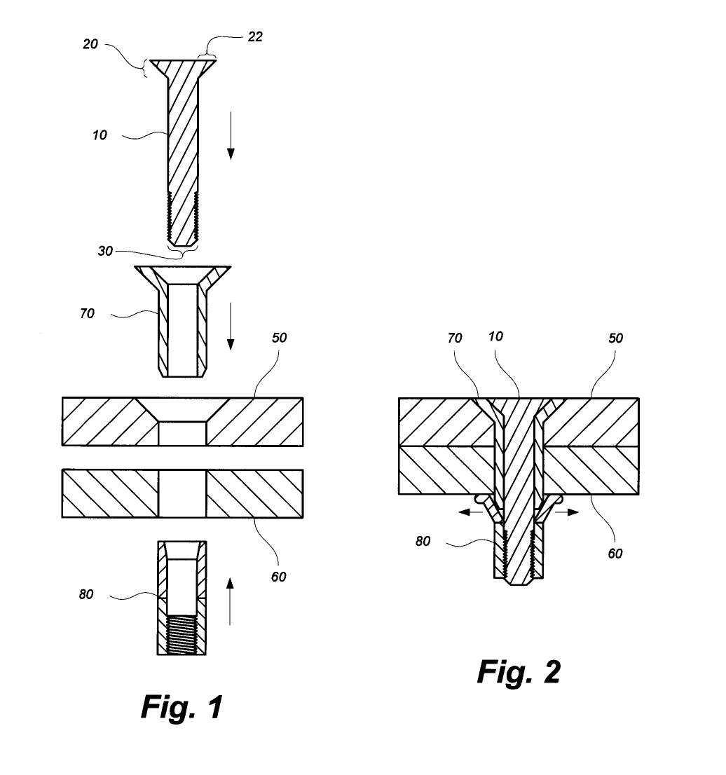

According to some exemplary implementations, disclosed is an FEED device for disassembling a fastener assembly. As shown in FIG. 1, fastener 10 may include head 20, flange 22, and shank 30. Shank 30 may have a known or determinable shape and geometry. For example, shank 30 may be generally cylindrical with a known outer diameter.

As shown in FIGS. 1 and 2, fastener 10 may include head 20 protruding from at least a portion of at least one of first frame 50 and second frame 60. Head 20 may include flange 22, corresponding to the portion of head 20 that extends radially beyond the outer diameter of shank 30.

Fastener 10 and sleeve 70 are components of a fastener assembly and configured to interface with each other. Components of the fastener assembly are further configured to interface with at least one of first frame 50 and second frame 60. Other or different components may be used to form a fastener assembly and nut 80 or other component may be attached to an end of a portion of the fastener assembly to fix the assembly.

In exemplary implementations, and as shown in FIGS. 1 and 2, wherein fastener 10 is configured to mate within sleeve 70, sleeve 70 is configured to mate within at least one of first frame 50 and second frame 60.

According to some exemplary implementations, fastener 10 is secured within sleeve 70 by interfacing with nut 80. For example, as shown in FIGS. 1 and 2, fastener 10 may extend through first frame 50 and second frame 60 whereby a portion thereof reaches nut 80. By further example, nut 80 may be threaded onto or otherwise secured to fastener 10. According to some exemplary implementations, as shown in FIG. 2, nut 80 may deform as it is advanced along fastener 10 and securely pressed onto second frame 60. Sleeve 70 may provide a taper, knurling, or other feature to facilitate or promote the adaptation of nut 80 while mating with fastener 10.

According to some exemplary implementations, fastener 10 provides tensional forces onto first frame 50 toward second frame 60 and nut 80 provides tensional forces onto second frame 60 toward first frame 50. According to some exemplary implementations, mating of fastener 10, sleeve 70, nut 80, and corresponding frame components achieves an axially tight fit, for example, which causes first frame 50 to be secured relative to second frame 60 as well as fastener 10, sleeve 70, and nut 80 to be axially secured relative to each other.

According to some exemplary implementations, mating of fastener 10, sleeve 70, nut 80, and corresponding frame components achieves an interference fit between at least two of the above. For example, fastener 10 may be rotationally fixed relative to sleeve 70. Various mechanisms are known for providing an interference fit for concentric components. For example, sleeve 70 may be compressed between fastener 10 and at least one of first frame 50 and second frame 60 when assembled.

According to some exemplary implementations, mating of fastener 10, sleeve 70, nut 80, and corresponding frame components achieves a rotationally loose fit. For example, fastener 10 may be capable of spinning freely (i.e., with nominal torque) or semi-freely (i.e., with significant torque) relative to sleeve 70. Such a configuration may prevent effective use of removal techniques that rely on application of force or torque, such as mechanical drilling.

According to some exemplary implementations, devices, systems, and methods of the present disclosure may be applicable to a variety of fastener assembly and frame configurations. Such configurations may include protruding or non-protruding, with or without a sleeve about the fastener, threaded or non-threaded, with or without fitted collars, etc. Those having ordinary skill in the art will recognize the variation and variety of fasteners which may be modified or eroded with the disclosed methods and devices, the modification or erosion thereof being within the scope of the present disclosure. Incorporated by reference, as if fully set forth herein, are the following: U.S. Pat. No. 4,102,036; U.S. Pat. No. 4,985,979; U.S. Pat. No. 5,018,920; U.S. Pat. No. 5,141,373; and U.S. Pat. No. 5,810,530.

According to some exemplary implementations, as shown in FIG. 2, head 20 may be flush with a surface of first frame 50 (non-protruding). For example, first frame 50 and sleeve 70 may include a countersink portion. While head 20 may extend only beyond some portions of first frame 50, it may simultaneously be substantially flush with the surface of first frame 50. According to some exemplary implementations, head 20 may extend beyond the entirety of first frame 50 (protruding) (not shown).

According to some exemplary implementations, it may be advantageous to facilitate removal of fastener 10 without separation thereof from a collar or other structure fixed thereto. For example, it may be advantageous to remove fastener 10 in a direction opposite the side containing head 20.

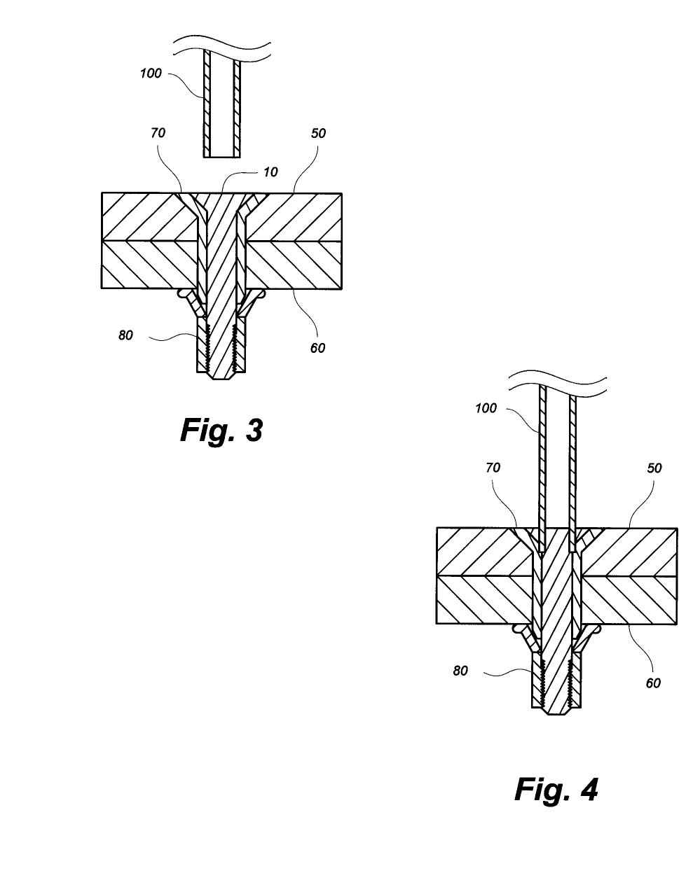

As shown in the figures, erosion electrode 100 of an FEED device may be of a variety of shape, sizes, and configurations. According to some exemplary implementations, erosion electrode 100 may be configured to remove head 20, flange 22, or at least portions thereof from shank 30. For example, as shown in FIGS. 3 and 4, erosion electrode 100 may be a hollow cylinder. As shown in FIG. 4, erosion electrode 100 may be advanced longitudinally along an axis. The axis may be coaxial with, parallel to, or otherwise aligned with a central axis of fastener 10 and sleeve 70. According to some exemplary implementations, erosion electrode 100 has an outer diameter equal to or exceeding the outer diameter of shank 30. According to some exemplary implementations, erosion electrode 100 has an outer diameter less than or equal to the outer diameter of sleeve 70. According to some exemplary implementations, erosion electrode 100 has an inner diameter less than or equal to the inner diameter of sleeve 70. According to some exemplary implementations, erosion electrode 100 has an inner diameter less than or equal to the outer diameter of shank 30.

According to some exemplary implementations, as shown in FIG. 4, erosion electrode 100 is configured to be advanced longitudinally through head 20 of fastener 10. According to some exemplary implementations, as shown in FIG. 4, erosion electrode 100 may be advanced to penetrate at least a portion of sleeve 70.

According to some exemplary implementations, erosion electrode 100 may be configured to create eroded space 200 by an FEED process. For example, a voltage difference may be provided from a power supply between erosion electrode 100 and at least one of fastener 10, sleeve 70, and any component in electric conductivity with one or more of the above. A dielectric fluid may be provided between erosion electrode 100 and one of the above. At a given voltage, the dielectric fluid may experience breakdown, and a plasma event may occur, causing at least a portion of fastener 10 or sleeve 70 to become eroded, leaving eroded space 200 at the location of the plasma event. A series of plasma events may cumulatively develop eroded space 200, wherein boluses of material are liberated from the workpiece.

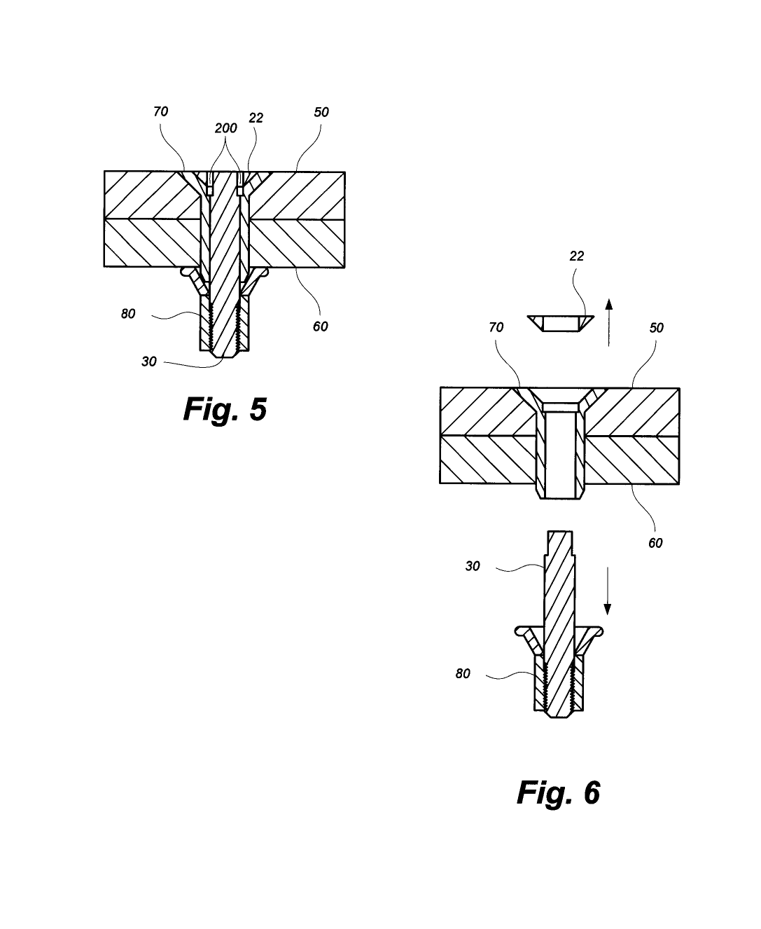

According to some exemplary implementations, as shown in FIG. 5, eroded space 200 may extend at least entirely through head 20 of fastener, separating flange 22 from shank 30. For example, eroded space 200 may extend to or into at least a portion of sleeve 70. Where desired, eroded space 200 may not extend into first frame 50 or second frame 60.

According to some exemplary implementations, methods and configurations may be provided to verify the location of erosion electrode 100 and extent of eroded space 200. For example, a reference point (such as a contact location) may be sensed and recording as erosion electrode 100 is in contact with an outer surface of fastener 10. The distance from the reference point may be tracked as a longitudinal distance travelled there from. The distance from the reference point to a transition from fastener 10 to sleeve 70 may be known or determinable, such that the distance traveled may be determined relative to at least one of the transition from fastener 10 to sleeve 70. Advancement of erosion electrode 100 may be stopped when the longitudinal distance travelled corresponds to the distance between the reference point and at least one location below or within sleeve 70. Other methods and mechanisms for tracking advancement of at least erosion electrode 100 may be employed, as shall be appreciated by those having ordinary skill in the relevant art, and as contemplated by the present disclosure.

According to some exemplary implementations, erosion electrode 100 may be rotated about an axis while being advanced longitudinally. Even in cases of rotatable fasteners, the electrode being without forcible contact can rotate without imparting significant torque or other forces on said fasteners.

According to some exemplary implementations, as shown in FIG. 6, at least flange 22 may be removed from shank 30. Where eroded space 200 extends at least to sleeve 70, flange 22 may have already been physically severed from shank 30. In such a case, removal of flange 22 requires no additional force or violence of fastener 10. Upon removal of flange 22, shank 30 may be removed in an opposite direction.

According to some exemplary implementations, where shank 30 retains an interference fit relative to sleeve 70, some force may be required to dislodge it. According to some exemplary implementations, the extent of eroded space 200 may weaken an interference fit. The process by which eroded space 200 is created may be determined accordingly. For example, the interface between shank 30 and sleeve 70 may be eroded until any interference fit is sufficiently weakened to facilitate removal of shank 30 without undue forces and pressure.

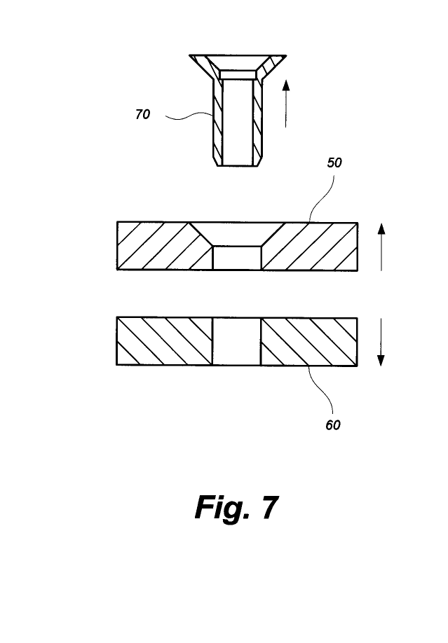

According to some exemplary implementations, as shown in FIG. 7, sleeve 70 may be removed. Where sleeve 70 has an interference fit relative to at least one of first frame 50 and second frame 60, creation of eroded space 200 or removal of shank 30 may disable or weaken such interference fit, facilitating removal of sleeve 70.

According to some exemplary implementations, as shown in FIG. 7, first frame 50 and second frame 60 may be separated one the fastener assembly is sufficiently disabled.

According to some exemplary implementations, other mechanisms for forming an eroded space 200 are disclosed herein. For example, erosion electrode 100 may include one or more point electrodes. A plurality of point electrodes and may be provided and rotated about an axis while advancing longitudinally. Erosion electrodes may cumulatively provide an outer diameter defined by the rotation about an axis. The rotation and advancement or point electrodes may result in an eroded space 200 similar to that caused by erosion electrode 100 as a hollow cylinder, as shown in FIG. 5. Accordingly, flange 22 may be removed in a manner as shown in FIG. 6.

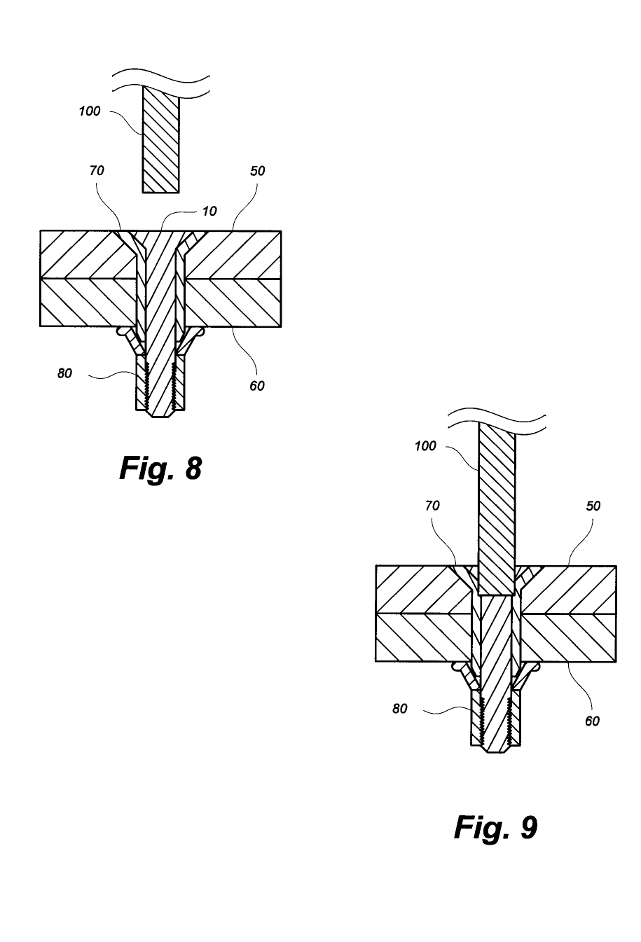

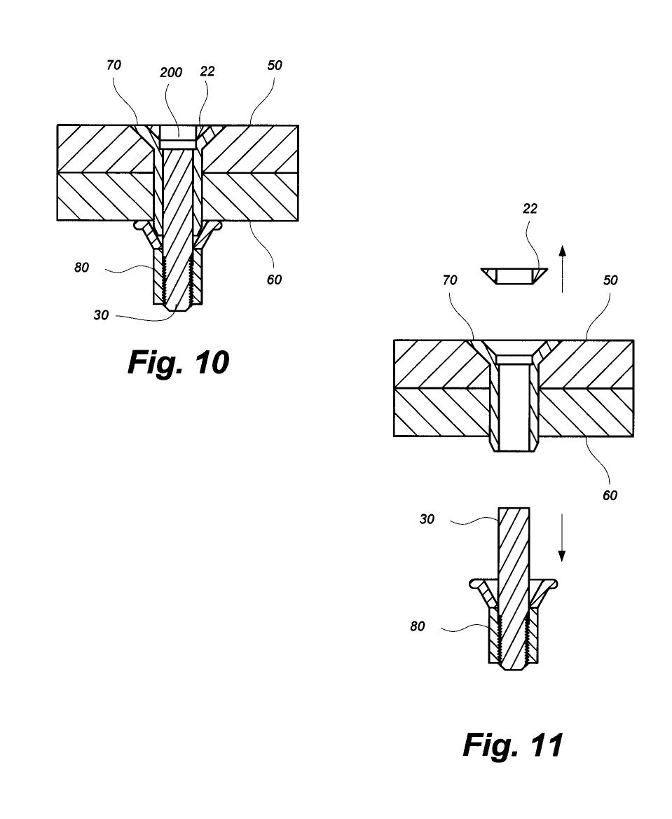

According to some exemplary implementations, erosion electrode 100 may be a solid cylinder, as shown in FIGS. 8 and 9. In such an embodiment, the inner diameter of erosion electrode may be considered as zero. As shown in FIG. 10, erosion electrode 100 may define an uninterrupted eroded space 200. Accordingly, flange 22 may be removed, as shown in FIG. 11. Sleeve 70 may likewise be removed, as shown in FIG. 7.

According to some exemplary implementations, erosion electrode 100 may rotate at least about an axis other than its own central axis. For example, erosion electrode 100 may have a central axis parallel to, but not coaxial with, the central axis of fastener 10. Erosion electrode 100 may also be rotated about its own central axis. Such rotation(s) may be performed contemporaneously with longitudinal advancement of erosion electrode 100. According to some exemplary implementations, eroded space 200 resulting from such operations may be similar to those shown in FIGS. 5 and 6 where erosion electrode 100 is sufficiently narrow, or similar to that shown in FIGS. 10 and 11, where erosion electrode 100 is sufficiently wide. Accordingly, removal of flange 22 may be facilitated thereby.

While the method and agent have been described in terms of what are presently considered to be the most practical and preferred implementations, it is to be understood that the disclosure need not be limited to the disclosed implementations. It is intended to cover various modifications and similar arrangements included within the spirit and scope of the claims, the scope of which should be accorded the broadest interpretation so as to encompass all such modifications and similar structures. The present disclosure includes any and all implementations of the following claims.

It should also be understood that a variety of changes may be made without departing from the essence of the disclosure. Such changes are also implicitly included in the description. They still fall within the scope of this disclosure. It should be understood that this disclosure is intended to yield a patent covering numerous aspects of the disclosure both independently and as an overall system and in both method and apparatus modes.

Further, each of the various elements of the disclosure and claims may also be achieved in a variety of manners. This disclosure should be understood to encompass each such variation, be it a variation of an implementation of any apparatus implementation, a method or process implementation, or even merely a variation of any element of these.

Particularly, it should be understood that as the disclosure relates to elements of the disclosure, the words for each element may be expressed by equivalent apparatus terms or method terms—even if only the function or result is the same.

Such equivalent, broader, or even more generic terms should be considered to be encompassed in the description of each element or action. Such terms can be substituted where desired to make explicit the implicitly broad coverage to which this disclosure is entitled.

It should be understood that all actions may be expressed as a means for taking that action or as an element which causes that action.

Similarly, each physical element disclosed should be understood to encompass a disclosure of the action which that physical element facilitates.

Any patents, publications, or other references mentioned in this application for patent are hereby incorporated by reference. In addition, as to each term used it should be understood that unless its utilization in this application is inconsistent with such interpretation, common dictionary definitions should be understood as incorporated for each term and all definitions, alternative terms, and synonyms such as contained in at least one of a standard technical dictionary recognized by artisans and the Random House Webster's Unabridged Dictionary, latest edition are hereby incorporated by reference.

Finally, all referenced listed in the Information Disclosure Statement or other information statement filed with the application are hereby appended and hereby incorporated by reference; however, as to each of the above, to the extent that such information or statements incorporated by reference might be considered inconsistent with the patenting of this/these disclosure(s), such statements are expressly not to be considered as made by the applicant(s).

In this regard it should be understood that for practical reasons and so as to avoid adding potentially hundreds of claims, the applicant has presented claims with initial dependencies only.

Support should be understood to exist to the degree required under new matter laws—including but not limited to United States Patent Law 35 USC 132 or other such laws—to permit the addition of any of the various dependencies or other elements presented under one independent claim or concept as dependencies or elements under any other independent claim or concept.

To the extent that insubstantial substitutes are made, to the extent that the applicant did not in fact draft any claim so as to literally encompass any particular implementation, and to the extent otherwise applicable, the applicant should not be understood to have in any way intended to or actually relinquished such coverage as the applicant simply may not have been able to anticipate all eventualities; one skilled in the art, should not be reasonably expected to have drafted a claim that would have literally encompassed such alternative implementations.

Further, the use of the transitional phrase “comprising” is used to maintain the “open-end” claims herein, according to traditional claim interpretation. Thus, unless the context requires otherwise, it should be understood that the term “compromise” or variations such as “comprises” or “comprising”, are intended to imply the inclusion of a stated element or step or group of elements or steps but not the exclusion of any other element or step or group of elements or steps.

Such terms should be interpreted in their most expansive forms so as to afford the applicant the broadest coverage legally permissible.

1. A method, comprising:
providing an erosion electrode to a fastener in at least one frame, the fastener having a sleeve surrounding at least a portion thereof, and the fastener having a head and a shank and,
creating an eroded space without contacting the electrode to the fastener or the sleeve, the eroded. space having an outer diameter exceeding the outer diameter of the shank and less than the outer diameter of the sleeve, the eroded space having an inner diameter less than the outer diameter of the shank, and the eroded space extending through the head. of the fastener, at least a portion of the shank, and at least a portion of the sleeve.

2. The method of claim a, wherein creating an eroded space comprises: providing a voltage difference between the erosion electrode and at least one of the fastener and the frame coating.

3. The method of claim 1, wherein creating an eroded space comprises: advancing the erosion electrode longitudinally along an axis of the fastener.

4. The method of claim 3, wherein creating an eroded space further comprises: rotating the erosion electrode as it is advanced longitudinally.

5. The method of claim 1, wherein the erosion electrode is a hollow cylinder.

6. The method of claim 1, wherein the erosion electrode is a solid cylinder and the inner diameter of the eroded space is zero.

7. The method of claim 1, wherein the erosion electrode is a plurality of pins.

8. The method of claim 1, whereby a flange of the head is separated from a remainder of the fastener,

9. The method of claim 1, wherein the frame remains intact.

10. The method of claim 3, wherein advancing the erosion electrode longitudinally along the axis of the fastener further comprises:
sensing and recording a contact location when the erosion electrode is in contact with an outer surface of the fastener;
tracking a longitudinal distance traveled relative to the contact position; and,
stopping advancement of the erosion electrode When the longitudinal distance traveled is equal to the distance between the contact position and at least one location beyond the head of the fastener.

11. The method of claim 1, further comprising: separating the head and the shank in opposite directions.

12. The method of claim 11, further comprising: removing the sleeve from the at least one frame.

13. The method of claim 11, wherein the at least one frame comprises a first frame and a second frame with opposing surfaces, whereby the method enable separation of the first frame from the second frame.

14. The method of claim r wherein the fastener has a rotationally loose fit within the sleeve.

15. A Forceless Electrical Erosion and Disintegration (FEED) device, comprising:
an erosion electrode having an outer diameter exceeding the outer diameter of a shank of a fastener and less than the outer diameter of a sleeve surrounding at least a portion of the fastener;
the erosion electrode further having an inner diameter less than the outer diameter of the shank; and,
wherein the erosion electrode is configured to be advanced longitudinally through a head of the fastener, at least a portion of the shank, and at least a portion of the sleeve.

16. The FEED device of claim 15, wherein the erosion electrode is a hollow cylinder.

17. The FEED device of claim 15, wherein the erosion electrode is a solid cylinder and the inner diameter of the erosion electrode is zero.

18. The FEED device of claim 15, wherein the erosion electrode is a plurality of pins.

19. The FEED device of claim 15, wherein the erosion electrode is configured to be rotated as it is advanced longitudinally.

20. The FEED device of claim 15, wherein the erosion electrode is configured to be rotated about an axis of rotation corresponding to a central axis of the fastener.

21. The FEED device of claim 15, further comprising: a power supply configured to provide a voltage difference between the erosion electrode and at least one of the fastener and the sleeve.

22. The FEED device of claim 15, further comprising: a ground electrode configured to contact at least one of the fastener and the sleeve.

23. The FEED device of claim 15, wherein the FEED device provides no significant torque to a fastener.

24. The FEED device of claim 15, wherein the fastener has a rotationally loose fit within the sleeve.
